(19) United States
(12) Patent Application Publication
(10) Pub. No.: US 2021/0178647 A1
(43) Pub. Date: Jun. 17, 2021

(54) MULTI-PART CORE INSERT

(71) Applicant: MHT Mold & Hotrunner Technology AG, Hochheim (DE)

(72) Inventors: Matthias Brinzing, Darmstadt (DE); Thomas Gebauer, Weiskirchen (DE); Marek Honisch, Hunstetten (DE); Christian Wagner, Mainz (DE)

(21) Appl. No.: 17/116,387

(22) Filed: Dec. 9, 2020

(30) Foreign Application Priority Data
Dec. 13, 2019 (DE) 10 2019 134 317.8

(51) Int. Cl. B29C 45/36; B29C 45/26

(52) U.S. Cl. CPC B29C 45/36; B29K 2105/258; B29C 45/2675; B29C 45/261

(57) ABSTRACT

The present invention concerns a multi-part core insert (1) for an injection molding mold (100) for the production of preforms having a two-part core having a longitudinal axis (10), wherein the two-part core has a lower core part (20) and an upper core part (30) arranged beside the lower core part (20) in the direction of the longitudinal axis, and a fixing element (40), wherein the fixing element (40) has an opening parallel to the longitudinal axis (10) for receiving the upper core part (30), and wherein the upper core part (30) can be fixed with the fixing element (40) at an end (22) of the lower core part (20). To provide a core insert for an injection molding mold, whose shaping portion can be easily and quickly exchanged, while at the same time ensuring the quality and functionality of the injection molding procedure, it is proposed according to the invention that the fixing element (40) and the upper core part (30) are of such a configuration that when the upper core part (30) is received in the opening a positively locking and/or force-locking connection can be produced at least in the axial direction between the upper core part (30) received in the fixing element (40) and the fixing element (40), and the fixing element (40) and the lower core part (30) are of such a configuration that the fixing element (40) can be fixed to the lower core part only in one position or in a plurality of positions which differ by rotation of the fixing element (40) relative to the lower core part (20) about the longitudinal axis (10), wherein only a finite number of positions, preferably a maximum of four positions, of the fixing element (40) relative to the lower core part (20) are possible.

The present invention concerns a multi-part core insert for an injection molding mold for the production of preforms having a two-part core having a longitudinal axis, wherein the two-part core has a lower core part and an upper core part arranged beside the lower core part in the direction of the longitudinal axis, and a fixing element, wherein the fixing element is substantially of a hollow-cylindrical configuration and has a longitudinal axis, wherein the fixing element has an opening parallel to the longitudinal axis for receiving the upper core part, and wherein the upper core part can be fixed with the fixing element at an end of the lower core part.

Core inserts of that kind are used in particular in injection molding molds for the injection molding of preforms. Such preforms can be for example PET preforms which are inflated in a further processing step to give PET bottles. To produce a preform a granular material comprising a plastic is plasticised, that is to say melted and homogenized. The plasticised melt is then injected under high pressure into a mold cavity of the injection molding mold.

A part of that mold cavity and thus a part of the shape of the preform is determined by the outside contour of the core insert, namely the inner part or the inner surface of the preform to be produced.

The plasticized melt remains in the mold cavity after injection until it has cooled down to such an extent that the preform is stable and can be removed. To ensure rapid cooling of the plasticized melt the core insert frequently has a cooling system which cools the preform at the interior thereof. For that purpose formed in the interior of the core insert is a passage system through which a cooling liquid is passed.

Those surfaces of the core insert that come into contact with the plasticized melt are subjected to an elevated level of wear. That is substantially because they are repeatedly subjected to large pressure and temperature fluctuations by virtue of the injection molding procedure.

In general core inserts of such injection molding molds are of a one-part configuration. In that case the complete core insert has to be replaced if the outside contour of a core insert is worn. Not infrequently the described injection molding molds are also used to produce preforms involving various contours. To change the contour of a preform at least the shaping part of the core insert has to be replaced. When using one-part core inserts however that also involves complete replacement of the core insert. It will be appreciated that complete replacement of the core inserts is both material-intensive and also time-intensive.

Core inserts are therefore known from the state of the art, which involve a two-part core insert, wherein only a part of the core insert contributes to the shape of the preform and is thus exposed to elevated wear. With such core inserts it is sufficient if only the corresponding part of the core insert is replaced when it is worn or if another form of preforms is to be produced. In that way it is possible to save on material.

In the case of such two-part core inserts however it is necessary to ensure that both parts of the core insert are reliably connected together to minimize wastage in the production of the preforms. If the parts are not reliably connected together and the part which contributes to the shape of the preform can move during the injection operation by for example performing a tilting movement relative to the other part of the core insert, that leads to an unwanted and incalculable change in the mold cavity in which the preform is being produced. Such uncontrollable changes in the mold cavity result at least in altered wall thicknesses for the preform, which in the worst-case scenario result in the preform being unusable. In addition there is the risk that cooling liquid escapes between the upper and lower core parts.

WO 2019/011969 therefore discloses for example a support ring which connects the two parts of the core insert together, by the support ring bracing the part of the core insert that contributes to the shape of the preform in the direction of the other part of the core insert that does not contribute to the shape of the preform. For that purpose the support ring extends along the lower core part that does not contribute to the shape so that the support ring can be fixed to a base plate which is disposed at an end of the rear core part, that faces away from the front core part of the core insert.

In that case however it has been found to suffer from the disadvantage that, for replacement of the front core part the complete core insert nonetheless has to be dismantled as the support ring is fixed to the base plate on which the entire core insert is mounted. Replacement of the core insert is therefore highly time-intensive.

As in the production of preforms in an injection molding method the largest possible number of preforms is to be produced in the shortest possible time outage of the installation because of replacement operations at the core inserts is advantageously to be kept as short as possible.

Taking the described state of the art as the basic starting point therefore the object of the present invention is to provide a core insert for an injection molding mold whose shaping portion can be easily and quickly replaced, while at the same time the quality and functionality of the injection molding operation is guaranteed.

According to the invention that object is attained by a multi-part core insert, as described hereinbefore, in which the fixing element and the upper core part are of such a configuration that when the upper core part is received in the opening a positively locking and/or force-locking connection can be produced at least in the axial direction between the upper core part received in the fixing element and the fixing element, and the fixing element and the lower core part are of such a configuration that the fixing element can be fixed to the lower core part only in one position or in a plurality of positions which differ by rotation of the fixing element relative to the lower core part about the longitudinal axis, wherein only a finite number of positions, preferably a maximum of four positions, of the fixing element relative to the lower core part are possible.

The advantage of the fixing element according to the invention is that in that way the upper core part is fixed directly to the lower core part, independently of the fixing of the lower core part to a base plate. Accordingly the upper core part can be particularly easily replaced by only the fixing element having to be released from the lower core part which is more easily accessible than a base plate on which a plurality of core inserts are frequently arranged in directly mutually adjacent relationship. The outage times of an injection molding installation because of conversion works are thus minimized.

The fixing element is of such a configuration that the upper core part can be received in the fixing element. For that purpose the fixing element has a through opening so that the fixing element is of a substantially hollow-cylindrical shape. The through opening extends parallel to the longitudinal axis. Through openings extending along the longitudinal axis are also deemed as being oriented parallel to the longitudinal axis. The upper core part of the core insert can be received in the through opening.

The upper and lower core parts are also of a substantially cylindrical cross-section. The expression “substantially cylindrical” or “substantially hollow-cylindrical” does not refer exclusively to exactly round shapes. Rather, core inserts of other cross-sectional shapes, for example squares, hexagons or other polygons, are also conceivable. The cross-sectional shape of the opening in the fixing element only has to be matched to the cross-sectional shape of the upper core part.

Because the fixing element can be fixed only in one position or only in a limited number of positions which differ only by a relative rotation of the fixing element with respect to the lower core part the fixing element can perform further functions like for example the provision of a fluid passage or the provision of a holding means for example for a sensor. In any case the fixing element can only be fixed to the lower core part in predetermined positions.

To receive the upper core part in the fixing element in an embodiment the multi-part core insert is of such a configuration that the upper core part and the opening of the fixing element have mutually corresponding abutment surfaces, wherein the abutment surfaces are preferably of such a configuration that an axial relative movement of the fixing element with respect to the upper core part in the direction of the part of the upper core part, that is towards the lower core part and/or a radial relative movement between the fixing element and the upper core part is limited.

Preferably the fixing element can be fitted on to the upper core part only from one side thereof in order to assemble the multi-part core insert according to the invention. At an end of the upper core part, that is towards the lower core part, the diameter thereof can be greater than a diameter of the opening in the fixing element so that it is not possible for the upper core part to be passed completely through the fixing element.

In a further embodiment of the multi-part core insert the corresponding abutment surfaces of the opening of the fixing element and the upper core part are conical. A conical surface is a portion on an outside surface (peripheral surface) of a truncated cone or a cone. A holding force can be particularly effectively exerted on the upper core part in a direction parallel to the longitudinal axis.

In a further embodiment the cone is of a such a configuration that its outside diameter becomes greater in the direction of the lower core part.

Alternatively in a further embodiment of the multi-part core insert the corresponding abutment surfaces can have two abutment surface portions arranged at an angle relative to each other, preferably perpendicular to each other, wherein preferably a respective one of the contact surface portions is parallel to the longitudinal axis of the fixing element. A combination with a conical abutment surface however is also conceivable.

In a further embodiment of the multi-part core insert the fixing element according to the invention is of such a configuration that the abutment surface of the fixing element and the abutment surface of the upper core part are matched to each other with a clearance fit. The result of the clearance fit of the two abutment surfaces is that the upper core part is mounted floatingly in the fixing element even in an assembled state of the multi-part core insert. In this case clearance fit means that the abutment surfaces at least in the radial direction are not in contact with each other or are not in contact over their full periphery so that there is a gap of for example a few micrometers.

This has the advantage that, when the multi-part core insert is assembled in an injection molding mold, by a so-called cavity insert being fitted over the upper core part, there is less wear at the upper core part as the upper core part can be slightly displaced with respect to the cavity insert. The clearance also provides that the wear at the fixing element into which the cavity insert engages is also reduced to achieve a stable connection between the core insert and the cavity insert.

The upper core part received in the fixing element is fixed to the lower core part by the fixing element in an assembled state of the multi-part core insert.

In the assembled state of the multi-part core insert the longitudinal axes of the upper and lower core parts as well as the fixing element are parallel to each other. Preferably all three components have a common central longitudinal axis which describes a rotational symmetry of the multi-part core insert.

Further preferably the mutually facing end faces of the upper and lower core parts are in contact with each other. In that respect it is particularly preferred if the two end faces adjoin each other in flush relationship. By way of example both end faces could be of the same inside and/or outside diameter.

A part of an outside contour of the upper core part contributes to the inside shape of the preform to be produced while the lower core part does not contribute to the shape of the preform and serves primarily for fixing the core insert to a base plate, that is to say a tool holding means, as well as the feed and discharge of cooling liquid.

To effectively cool a preform it is appropriate for the shaping outside contour of the upper core part to be cooled by a permanent water feed and discharge. For that purpose a through bore is provided in the lower core part and a blind bore corresponding to the bore in the lower core part is provided in the upper core part. Preferably the bores in the lower and upper core parts are of such a configuration that the cross-section thereof is substantially identical to avoid unwanted turbulence in the cooling liquid.

In the assembled state of the multi-part core insert it is thus possible for a cooling liquid to circulate in the upper and lower core parts. Optionally a guide element can be fitted into both the lower core part and also the upper core element for that purpose.

In addition in a further embodiment at least one of the two end faces has a groove for receiving a sealing element, for example an O-ring. When the O-ring is in the groove and the lower and upper core parts are connected together then the O-ring seals off the two portions relative to each other so that no cooling liquid can escape.

In order additionally to avoid unwanted turbulence in the cooling liquid it is important to ensure that the two core parts are fitted together as accurately as possible. That is relevant in particular in those cases in which the bores for the cooling liquid do not extend uniformly about the central longitudinal axis of the multi-part core insert. For that purpose in an embodiment the fixing element, the upper core part and the lower core part are of such a configuration that only a finite number of positions of the upper core part relative to the lower core part is possible. In other words, the fixing element according to the invention allows the upper core part to be fixed to the lower core part only in certain angular positions so that in each position the arrangement ensures that the bores for the cooling liquid adjoin each other in flush relationship in the upper and lower core parts.

To ensure that, in an embodiment the fixing element and/or the lower core part at a given position on the end face towards the respective other component can have a projection or a depression into which the projection, for example an arresting pin engages when the multi-part core insert is assembled. Accordingly only one position exists, in which the fixing element is fixed relative to the lower core part.

To reliably connect the fixing element and the lower core insert together in an embodiment the multi-part core insert is of such a configuration that the lower core part and the fixing element have mutually corresponding contact surfaces which in an assembled state of the multi-part core insert are in contact with each other.

In a further embodiment of the multi-part core insert the mutually corresponding contact surfaces of the lower core part and the fixing element have two contact surface portions which are in angled relationship with each other, preferably being perpendicular, wherein preferably a respective one of the contact surface portions of the lower core part and the fixing element is oriented parallel to the longitudinal axis of the fixing element. The two mutually angled contact surface portions permit better holding for the fixing element and thus better fixing between the upper and the lower core parts. In addition those contact surfaces provide that tilting of the two portions relative to each other during the injection molding operation is prevented. The same applies for the abutment surfaces between the upper core part and the fixing element, that are arranged in angled relationship with each other in an embodiment.

In an embodiment the multi-part core insert is of such a configuration that at least one projection and preferably at least two projections are provided in the radial direction at one of the contact surface portions, that is parallel to the longitudinal axis, of the lower core part or the fixing element, and wherein provided at the corresponding contact surface portion, that is parallel to the longitudinal axis, of the lower core part or the fixing element is a substantially L-shaped recess into which the projection of the corresponding contact surface engages in an assembled state of the multi-part core insert.

The lower core part and the fixing element are connected by interengagement along the longitudinal axis and opposite rotation about the longitudinal axis, preferably by about 20° through 50°, and are also separated again in that way. This connection which is operative on the basis of the principle of a bayonet fixing leads to a positively locking and/or force-locking connection between the fixing element and the lower core part.

The projections can be arranged either at the contact surfaces of the fixing element or at the contact surfaces of the lower core part, wherein the L-shaped recess is arranged in the correspondingly opposite contact surface so that the projection engages into the recess.

The advantage of such a bayonet fixing-type connection is that then the upper core part can be particularly easily released from the lower core part and the upper core part is always arranged in given defined positions on the lower core part when the multi-part core insert is assembled. At the same time the respective contact surface portions ensure a reliable connection between the lower core part and the fixing element.

In a further embodiment the lower core part at an end towards the fixing element has an end portion projecting from the end face in the axial direction and the fixing element at an end towards the lower core part has a depression corresponding to the end portion of the lower core part. In an assembled state of the core insert the depression in the fixing element and the projecting end portion of the lower core part are thus in contact with each other. It will be appreciated that conversely the lower core part can also have a depression at an end towards the fixing element and the fixing element at an end towards the lower core part can have a projecting end portion corresponding to the depression in the lower core part, which in an assembled state again come into contact with each other, that is to say engage into each other.

Such a configuration of the connection between the lower core part and the fixing element is advantageous in particular when the core insert is mounted horizontally so that increased lever forces act on the upper core part. The described connection by way of the depression and the projecting end portion between the lower core part and the fixing element leads in that case to an improved connection as neither the fixing element nor the upper core part can deviate with respect to the lower core part. Stable fixing of the core insert is again important as described hereinbefore in terms of the quality of the preforms produced as in the event of incorrect positioning of the core insert the preform may suffer from differing wall thicknesses or in the worst-case scenario the preforms may be unusable at all.

In a further embodiment the fixing element in an assembled state of the multi-part core insert is arranged on the lower core part in such a way that an outside surface of the fixing element terminates flush with an outside surface of the lower core part. That is particularly advantageous as in practice a plurality of core inserts are frequently positioned in directly mutually adjoining relationship in order to be able to simultaneously produce a plurality of preforms. In that respect it is appropriate to avoid unnecessary protrusions for example due to the fixing element. By virtue of the flush relationship of the outside surfaces of the fixing element and the lower core part the core inserts can be positioned as closely as possible to each other and more preforms can be produced in one injection molding process.

In a further embodiment of the multi-part core insert the fixing element is of such a configuration that the fixing element has at least one through hole in the region of the contact surfaces of the lower core part and the fixing element for at least one fixing means. The lower core part has a corresponding bore, into which the at least one fixing means is introduced through the through hole in the fixing element in order in that way to make a positively locking and/or force-locking connection. The term fixing means is used to denote for example screws or pins which fit into the corresponding bores on the lower core part. The bores preferably involve threaded bores which are matched to the fixing means.

Preferably the bores and the through holes are arranged at an acute angle relative to the longitudinal axis of the core insert in such a way that the fixing element and therewith also the upper core part is pulled in the direction of the lower core part when the fixing means are introduced into the bores through the through holes.

In a further embodiment the fixing element and the lower core part respectively have at least one blow-out passage for blow-out air. After the injection molding operation blow-out air is pressed through the blow-out air passages against the cooled preform primarily in the axial direction so that removal of the preform from the mold is facilitated. In order at that location to ensure the highest possible transmission of force exerted by the blow-out air on the preform it is advantageous if the passage of the lower core part directly adjoins the passage of the fixing element in the axial direction. Any random deflections or misfits depending on the respective positioning in the passages which divert or deflect the flow of air would lead to a reduction in that force. The multi-part core insert according to the invention ensures that the fixing element and the lower core part can be assembled only in such a way that the passages directly adjoin each other in the axial direction.

In a further embodiment at an end towards the lower core part the fixing element has a preferably frustoconical depression. By way of example a collar or another corresponding portion of the injection molding mold can be received in that depression to complete the mold cavity for the preform. At the same time engagement of a collar or another corresponding portion of the injection molding mold leads to additional stabilization of the upper core part during the injection molding process by the corresponding part having corresponding contact surfaces which come into contact with corresponding contact surfaces on the upper core part.

It has also been found that a given arrangement of the blow-out passages relative to the arrangement of the collar is of importance for the longevity in particular of the fixing element. Usually a collar comprises two parts which are separated by a small gap in the middle of the collar. If the openings of the blow-out passages are disposed in the region of the gaps then that leads to an increased force acting on the fixing element, which in turn after a certain time leads to cracking in the fixing element. If however the openings of the blow-out passages are slightly turned relative to the gap in the collar the cracking can be reduced and thus the longevity of the fixing element can be markedly increased. For that reason also it is advantageous if the fixing element can be fixed to the lower core part in a defined position.

In a further embodiment the materials of the upper and lower core parts and the fixing element are different. By virtue of the use of different materials the different external influences which act on the respective components of the multi-part core insert are taken into consideration. Thus it is conceivable that the lower core part and the fixing element comprise a material which is more robust and is of higher strength in relation to forces acting thereon than the upper core part. In regard to the lower core part and/or the fixing element it is possible at the same time to use materials which otherwise would not be used in the injection molding process as those materials have properties which would have an adverse effect on the melt, for example thermal conduction properties, but at the same time have more suitable mechanical properties than materials which can come into contact with the melt. Thus the upper core part can also have a special coating which for example facilitates removal of the preform from the mold.

At least in an embodiment therefore an injection molding mold for the production of preforms having one of the described multi-part core inserts and a cavity insert is also claimed, wherein in an assembled state the injection molding mold has a pre-chamber whose contour corresponds to the contour of the preform to be produced.

The core insert and the cavity insert in this case have respective shaping portions which in the assembled state of the injection molding mold form at least a part of the contour of the mold cavity.

The cavity insert of the injection molding mold can be of a two-part configuration and can comprise a hollow-cylindrical portion and a bottom insert. The bottom insert can have an opening, by way of which the plasticized melt is injected. That opening is also referred to as the gate.

The blow-out passages can also be used during the injection molding operation for venting the mold cavity by the air displaced by the mold flowing out of the mold cavity by way of the blow-out passages. For that purpose in a further embodiment of the present invention the fixing element has portions which which form the contour portion. The consequence of this is that the fixing element is in communicaion with the mold cavity and can therefore be used for venting the mold cavity during the injection molding operation.

For many uses however it may also be advantageous if the fixing element does not have any portions which form the contour portion. Then the fixing element can be in the form of a standard part which can be used for different inserts. In that case individual adaptation of the core insert to the desired contour of the preform is effected exclusively by means of the upper core part and the cavity insert. All other parts of the core insert are independent of the contour of the preform and can be stocked at the injection molding mold manufacturer.

In a further embodiment the injection molding mold additionally has a collar, wherein the collar has a shaping portion for forming a thread on a preform and wherein the collar at an end towards the fixing element has contact surfaces corresponding to a frustoconical recess of the fixing element. In the assembled state of the injection molding mold the contact surfaces of the collar and the frustoconical depression of the fixing element are in engagement with each other in positively locking relationship.

It is advantageous if in such an embodiment the core is also mounted floatingly as in that case there is less friction upon introduction of the collar into the fixing element and thus also less wear at the fixing element and the holding ring respectively.

To be able to easily remove the preform from the injection molding mold in an embodiment the collar is of a two-part configuration so that the preform can be removed from the injection molding mold by moving those two parts away from each other.

In general removal of a preform from the injection molding mold is effected by opening the two-part collar and “spreading” the injection molding mold at that location. After removal the injection molding mold moves together again to be able to perform a further injection molding operation. When the injection molding mold is brought together in particular the parts experience high forces at which the injection molding mold opens. Thus for example frictional forces can occur or upon hitting together the bodies are subject to a compression effect and pulse transmission. The wear is particularly high in particular at those parts as a result. The parts of the core insert which are subject to that wear include the upper core part and the fixing element. By virtue of the multi-part configuration of the core insert only the worn parts have to be replaced while the other parts can continue to be used. With the core insert according to the invention replacement of the parts is effected with a saving of time so that more preforms can be produced in a shorter time and production installations can be more easily converted to different forms of the preforms.

In addition by virtue of the frictional forces which are acting while the injection molding mold is being brought together an exact fit is formed between certain surface points of the upper core part and the fixing element on the one hand and corresponding surface points of the cavity insert and the collar on the other hand. That fitting relationship however is given only for a given position of the fixing element and the upper core insert. Even a slight rotation of the fixing element and the upper core insert, when the injection molding mold is brought together again, provides that other surface points come into contact with those of the cavity insert and the collar and renewed wear occurs at that location because of the frictional forces. If it is therefore ensured that the fixing element and the upper core insert are always positioned in the same position relative to the lower core part then wear of the injection molding components is reduced.

Different receptacles and containers can be formed from the preforms, which for example can involve different material thicknesses, different lengths or different shapes. The shape of the preform is determined by the contour-forming portions of the collar, the cavity insert, the upper core part and optionally the fixing element. The multi-part configuration of the injection molding mold and the core insert therefore permits a variation in the contour of the preforms by exchanging individual ones or all of those parts. In addition the multi-part configuration of the core insert represents an additional cost saving as only the upper core part has to be changed by virtue of that structure in order to provide a change in contour while the lower core part can be used for different upper core parts.

Further advantages, features and possible uses will be apparent from the following description of preferred embodiments and the accompanying Figures. The same components in the Figures are denoted by the same references. In the Figures:

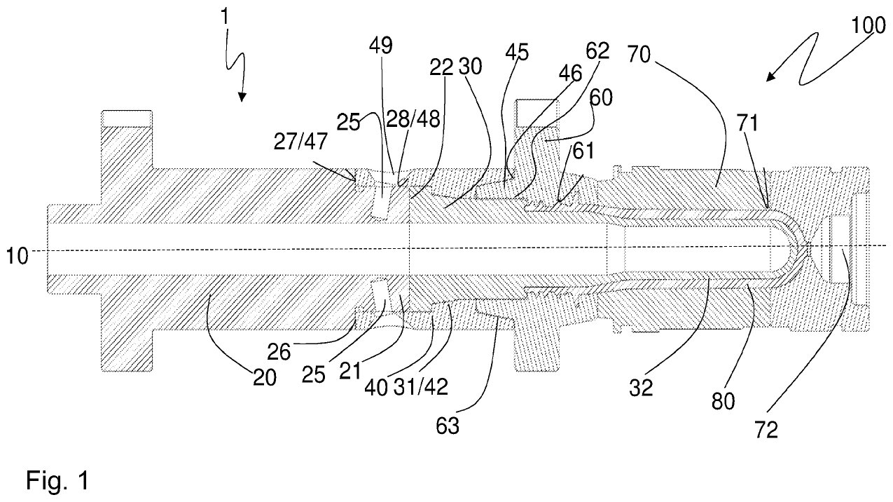

FIG. 1 shows a sectional view of an injection molding mold with an embodiment of the core insert,

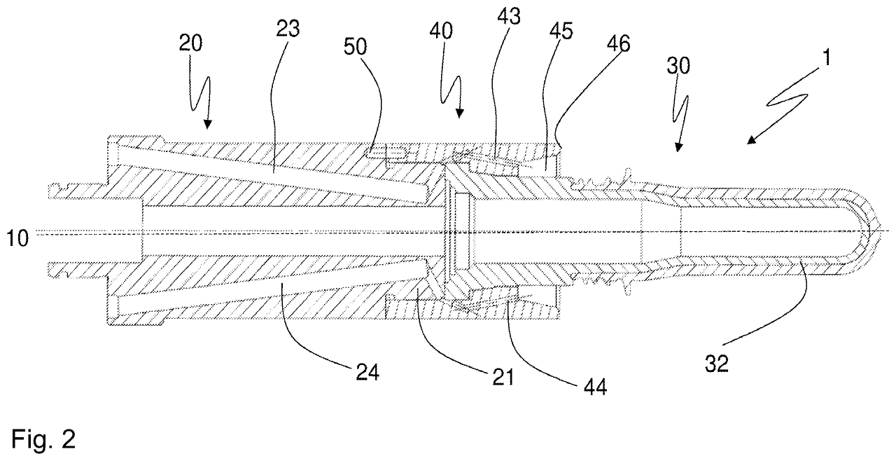

FIG. 2 shows a sectional view of an embodiment of the core insert with preform but without cavity insert and collar, and

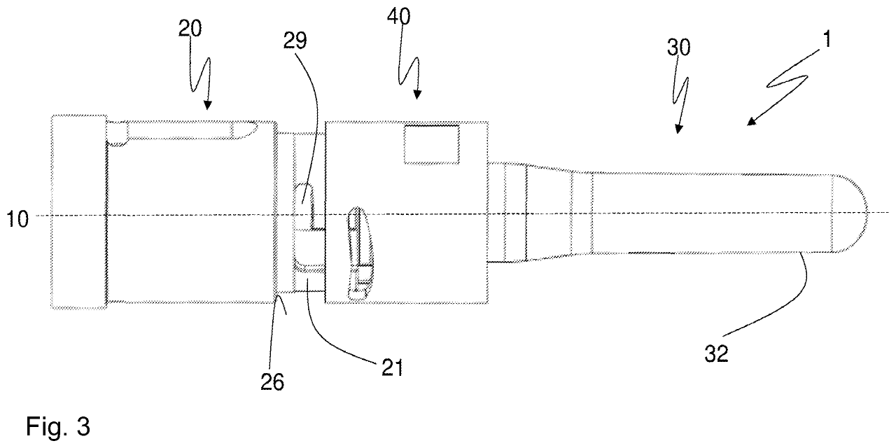

FIG. 3 shows a sectional view of another embodiment of the core insert.

FIG. 1 shows an injection molding mold 100 having a multi-part core insert 1 which is rotationally symmetrical about a longitudinal axis 10, a collar 60 and a cavity insert 70. The multi-part core insert 1 has a lower core part 20, an upper core part 30 and a fixing element 40, all components being of a substantially cylindrical structure. The fixing element 40 has an opening in the axial direction. The diameter of the opening however varies in the axial direction to ensure a positively locking connection both to the upper core part 30 and also the lower core part 20.

The lower core part 20 has an end portion 21 which projects in the axial direction from the end face 26, wherein provided in the end portion 21 are two threaded bores 25 which serve for fixing the fixing element 40 to the lower core part 20. The threaded bores 25 are arranged at an acute angle relative to the longitudinal axis 10.

The upper core part 30 is fixed to the lower core part 20 by means of the fixing element 40. For that purpose at an end towards the lower core part 20 the opening of the fixing element 40 is of such a diameter that the projecting end portion 21 of the lower core part 20 can be received in positively locking relationship. In that way the fixing element 40 and the lower core insert 20 have two mutually perpendicular contact surface portions 27, 28, 47, 48, with the contact surface portions 28, 48 being arranged parallel to the longitudinal axis 10 of the fixing element 40.

Disposed in the region of the parallel contact surfaces 28, 48 in the fixing element 40 are through bores 49 into which a fixing means, for example a screw (not shown) can be introduced, which engages into the threaded bores 25 in the lower core part 20. In that way a force is produced in particular in the radial direction between the fixing element 40 and the lower core part 20.

The outside diameters of the lower core part 20 and the fixing element 40 are so selected that their outside surfaces terminate flush.

To receive the upper core part 10 in the fixing element 40 the opening of the fixing element 40 is further of such a configuration that the upper core part 30 can be received in the opening. The upper core part 30 and the opening of the fixing element 40 have mutually corresponding abutment surfaces 31, 42 of a conical configuration. Adjoining the conical abutment surfaces in the direction of the lower core part 20 are two contact surface portions which are perpendicular to each other, one of the contact surface portions in turn extending parallel to the longitudinal axis 10.

A fixed connection is achieved between the fixing element 40 and the upper core part 30 by the combination of mutually perpendicular contact surface portions and conical contact surfaces 31, 42. The same applies to the connection between the fixing element 40 and the lower core part 20 so that overall tilting of the upper core part 30 relative to the lower core part 20 is prevented.

In order to be able to release a preform which is formed in a mold cavity 80 from the injection molding mold 100 as quickly as possible the multi-part core insert 1 has a cooling system. For that purpose a through bore in which a cooling liquid is guided is disposed in the lower core part 20. The upper core part 30 has a blind bore for guiding cooling liquid, the diameter thereof corresponding to the diameter of the through bore in the lower core part 20.

By virtue of the fixing of the fixing element 40 to the lower core part 20 the upper core part 30 is arranged on the lower core part 20 in such a way that there are only two possible positions for the arrangement of the fixing element 40, wherein the bores of the upper and lower core parts 20, 30 for carrying the cooling fluid in any event adjoin each other in flush relationship.

To produce a preform the injection molding mold 100 has a mold cavity 80, the contour of which corresponds to the contour of the preform to be produced. The upper core insert 30 and the cavity insert 70 have respective shaping portions 32, 71 which form a part of the contour of the mold cavity 80. The other part of the mold cavity 80 is formed by a shaping portion 61 of the collar 60, the shaping portion 61 of the collar 60 being of such a configuration that a thread is formed on a preform.

At an end towards the fixing element 40 the collar has contact surfaces 63 which correspond to a frustoconical depression 45 of the fixing element 40 at an end 46 thereof, that is towards the lower core part 20, so that the contact surfaces 63 of the collar 60 and the surface of the frustoconical depression 45 of the fixing element 40 are in mutual engagement in positively locking relationship. In addition the collar 60 has contact surfaces 62 which are parallel to the longitudinal axis 10 and which are in contact with the upper core part 30. In that way the upper core insert 30 is additionally stabilized even more.

The cavity insert 70 has a gate 72, by way of which the plasticized melt is injected into the mold cavity 80 during the injection molding operation, thereby forming a preform.

When the injected plasticized melt is cooled the cavity insert 70 and the collar 60 are removed by the components being moved away in the axial direction from the multi-part core insert 1. The preform initially remains on the core insert as shown in FIG. 2. To remove the finished preform from the upper core part 30 blow-out air is blown through blow-out passages 23, 24, 43, 44, which exerts a force on the preform parallel to the longitudinal axis 10 so that the preform is detached from the upper core part 30.

The blow-out passage 23 and the blow-out passage 24 of the lower core part 20 are arranged at opposite sides of the lower core part 20. The two blow-out passages 43, 44 of the fixing element 40 are directly in communication with the blow-out passages 23, 24 of the lower core part 20 and are arranged between the through bores 49. The blow-out passages 43 and 44 of the fixing element 40 open into the depression 45 of the fixing element 40, which is at an end 46 of the fixing element 40, that is facing away from the lower core part 20. The depression 45 is of a frustoconical configuration. By virtue of the defined positioning of the fixing element 40 relative to the lower core part 20 the openings of the blow-out passages 23, 24, 43, 44 are disposed in mutually superposed relationship directly in the direction of the longitudinal axis 10. The defined positioning is achieved by an arresting pin 50.

The material of the upper core part 30, the cavity insert 70 and the collar 60 is so selected that it has particularly high thermal conductivity in order of cool down the preform as quickly as possible. In addition the portions of those components, that form the mold cavity 80, are coated with a coating to facilitate release of the preform from the injection molding mold 100. The fixing element 40 and the lower core part 20 in contrast are made from a particularly robust steel which particularly well withstands the forces acting thereon.

FIG. 3 shows an embodiment of a multi-part core insert 1 in which a different fixing mechanism for the fixing element 40 on the lower core part 20 was adopted. The upper core part 30 can be received in the fixing element 40 as described hereinbefore.

To fix the fixing element 40 to the lower core part 20 an L-shaped recess 29 is arranged in the end portion 21. For making the force-locking connection between the fixing element 40 and the lower core part 20 the fixing element 40 at the inside surface delimiting the depression in the radial direction further has a projection which engages into the L-shaped recess 29 when the fixing element 40 is pushed in the axial direction on to the lower core part 20. By virtue of a subsequent rotary movement about the longitudinal axis 10 the projection moves into the portion of the L-shaped recess 29, that is oriented perpendicularlly to the longitudinal axis 10, and provides that the fixing element 40 and the lower core part 20 are clamped relative to each other.

This connection based on the principle of a bayonet fixing allows particularly rapid and simple replacement of the upper core part 30 when it is worn or if another mold cavity 80 is to be formed.

For the purposes of the original disclosure it is pointed out that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. A comprehensive explicit representation of all conceivable combinations of features is dispensed with here only for the sake of brevity and readability of the description.

While the invention has been illustrated and described in detail in the drawings and the preceding description that illustration and description is only by way of example and is not deemed to be a limitation on the scope of protection as defined by the claims. The invention is not limited to the disclosed embodiments.

Modifications in the disclosed embodiments are apparent to the man skilled in the art from the drawings, the description and the accompanying claims. The drawings are true to scale. In the claims the word ‘have’ does not exclude other elements or steps and the indefinite article ‘a’ does not exclude a plurality. The mere fact that certain features are claimed in different claims does not exclude the combination thereof. References in the claims are not deemed to be a limitation on the scope of protection.

### LIST OF REFERENCCES

1 multi-part core insert
10 longitudinal axis
20 lower core part
21 projecting end portion
22 end of the lower core part
23, 24 blow-out passage of the lower core part
25 threaded bore
26 end face of the lower core part
27, 28 contact surfaces of the lower core part
29 L-shaped recess
30 upper core part
31, 42 abutment surfaces of the upper core part and the fixing element
32 shaping portion of the upper core part
40 fixing element
43, 44 blow-out passage of the fixing element
45 depression
46 end of the fixing element
47, 48 contact surfaces of the fixing element
49 through bore
50 arresting pin
60 collar
61 shaping portion of the collar
62 contact surface of the collar that is parallel to the longitudinal axis
63 conical contact surface of the collar
70 cavity insert
71 shaping portion of the cavity insert
72 gate
80 mold cavity
100 injection molding mold

1. A multi-part core insert (1) for an injection molding mold (100) for the production of preforms having
a two-part core having a longitudinal axis (10), wherein the two-part core has a lower core part (20) and an upper core part (30) arranged beside the lower core part (20) in the direction of the longitudinal axis, and
a fixing element (40),
wherein the fixing element (40) has an opening parallel to the longitudinal axis (10) for receiving the upper core part (30), and
wherein the upper core part (30) can be fixed with the fixing element (40) at an end (22) of the lower core part (20).
characterised in that
the fixing element (40) and the upper core part (30) are of such a configuration that when the upper core part (30) is received in the opening a positively locking and/or force-locking connection can be produced at least in the axial direction between the upper core part (30) received in the fixing element (40) and the fixing element (40), and
the fixing element (40) and the lower core part (30) are of such a configuration that the fixing element (40) can be fixed to the lower core part only in one position or in a plurality of positions which differ by rotation of the fixing element (40) relative to the lower core part (20) about the longitudinal axis (10), wherein only a finite number of positions of the fixing element (40) relative to the lower core part (20) are possible.

2. A multi-part core insert (1) as set forth in claim 1 wherein the upper core part (30) and the opening of the fixing element (40) have mutually corresponding abutment surfaces (31, 42).

3. A multi-part core insert (1) as set forth in claim 2 wherein the corresponding abutment surfaces (31, 42) are conical.

4. A multi-part core insert (1) as set forth in claim 2 wherein the corresponding abutment surfaces (31, 42) have two mutually perpendicular abutment surface portions.

5. A multi-part core insert (1) as set forth in claim 1 wherein the fixing element (40) is of such a configuration that the abutment surface (42) of the fixing element (40) and the abutment surface (31) of the upper core part (30) are matched to each other with a clearance fit so that even in an assembled state of the multi-part core insert (1) the upper core part (30) is mounted floatingly in the fixing element (40) so that the abutment surfaces (31, 42) at least in the radial direction are not in contact with each other or not in contact over the full periphery.

6. A multi-part core insert (1) as set forth in claim 1 wherein the lower core part (20) and the fixing element (40) have mutually corresponding contact surfaces (27, 28, 47, 48) which are in contact with each other in an assembled state of the multi-part core insert (1).

7. A multi-part core insert (1) as set forth in claim 6 wherein the mutually corresponding contact surfaces of the lower core part (20) and the fixing element (40) have two mutually perpendicular contact surface portions (27, 28, 47, 48).

8. A multi-part core insert (1) as set forth in claim 7 wherein at least one projection are provided in the radial direction at one of the contact surface portions (28, 48) which are parallel to the longitudinal axis, and wherein provided at the corresponding contact surface (28, 48) which is parallel to the longitudinal axis (10) is a substantially L-shaped recess (29) into which the projection of the corresponding contact surface (28, 48) engages in an assembled state of the multi-part core insert (1) so that there is a positively locking and/or force-locking connection between the fixing element (40) and the lower core part (20).

9. A multi-part core insert (1) as set forth in one of the preceding claims wherein at an end towards the fixing element (40) the lower core part (20) has an end portion (21) projecting from the end face (26) in the axial direction and wherein at an end towards the lower core part (20) the fixing element (40) has a depression corresponding to the end portion (21) of the lower core part (20) so that the depression in the fixing element (40) and the projecting end portion (21) of the lower core part (20) are in contact with each other or wherein the lower core part (20) has a depression at an end (26) towards the fixing element (40) and wherein at an end towards the lower core part (20) the fixing element (40) has a projecting end portion corresponding to the depression in the lower core part (20) so that the projecting end portion of the fixing element (40) and the depression in the lower core part (20) are in contact with each other.

10. A multi-part core insert (1) as set forth in claim 9 wherein the fixing element (40) in an assembled state of the multi-part core insert (1) is so arranged on the lower core part (20) that an outside surface of the fixing element (40) terminates flush with an outside surface of the lower core part (20).

11. A multi-part core insert (1) as set forth in claim 6 wherein the fixing element (40) is of such a configuration that the fixing element (40) has at least one through hole (49) in the region of the contact surfaces (27, 28, 47, 48) of the lower core part (20) and the fixing element (40) for at least one fixing means and wherein the lower core part (20) has at least one bore (25), preferably a threaded bore, wherein the at least one fixing mean is introduced through the through hole (49) in the fixing element (40) into the bore (25) of the lower core part (20) to make a positively locking and/or force-locking connection.

12. A multi-part core insert (1) as set forth in claim 1 wherein the fixing element (40) and the lower core part (20) respectively have at least one blow-out passage (23, 24, 43, 44) for blow-out air and wherein the fixing element (40) in an assembled state of the multi-part core insert (1) is so fixed to the lower core part (20) that the blow-out passages (23, 24, 43, 44) adjoin each other directly in the axial direction.

13. A multi-part core insert (1) as set forth in claim 1 wherein at an end (45) facing away from the lower core part (20) the fixing element (40) has a depression (45).

14. An injection molding mold (100) for the production of preforms comprising a multi-part core insert (1) as set forth in claim 1 and a cavity insert (70), wherein in an assembled state the injection molding mold (100) has a mold cavity (80) whose contour corresponds to the contour of the preform to be produced, wherein the core insert (1) and the cavity insert (70) respectively have shaping portions (32, 71) which in the assembled state of the injection molding mold (100) form at least a part of the contour of the mold cavity (80).

15. An injection molding mold as set forth in claim 14 having a collar (60), wherein the collar (60) has a shaping portion (61) for forming a thread on a preform, wherein there is provided a core insert (1) as set forth in claim 13 and the collar (60) at an end towards the fixing element (40) has contact surfaces (63) corresponding to the frustoconical depressions (45) in the fixing element (40) so that in the assembled state of the injection molding mold (100) the contact surfaces (63) of the collar (60) and the frustoconical depression (45) of the fixing element (40) are in engagement with each other in positively locking relationship.

16. A multi-part core insert (1) as set forth in claim 2, wherein the abutment surfaces are preferably of such a configuration that an axial relative movement of the fixing element (40) with respect to the upper core part (30) in the direction of the part of the upper core part (30), that is towards the lower core part (20) and/or a radial relative movement between the fixing element (40) and the upper core part (30) is limited.

17. A multi-part core insert (1) as set forth in claim 4 wherein a respective one of the abutment surface portions of the upper core part (30) and the opening of the fixing element (40) is parallel to the longitudinal axis (10) of the fixing element (40).

18. A multi-part core insert (1) as set forth in claim 7 wherein a respective one of the contact surface portions (28, 48) of the lower core part (20) and the fixing element (40) is oriented parallel to the longitudinal axis (10).

19. A multi-part core insert (1) as set forth in claim 8 wherein at least two projections are provided in the radial direction at one of the contact surface portions (28, 48) which are parallel to the longitudinal axis.

20. A multi-part core insert (1) as set forth in claim 8 wherein the L-shaped recess (29) and the projection or projections are of such a configuration that the lower core part and the fixing element can be connected together by interengagement along the longitudinal axis and opposite rotation about the longitudinal axis through an angle of rotation which is best between 20° and 50°.
